(19) United States
(12) Patent Application Publication
(10) Pub. No.: US 2025/0220738 A1
(43) Pub. Date: Jul. 3, 2025

(54) PARAMETER OBTAINING METHOD AND APPARATUS, FIRST NETWORK FUNCTION, AND SECOND NETWORK FUNCTION

(71) Applicant: VIVO MOBILE COMMUNICATION CO., LTD., Dongguan (CN)

(72) Inventor: Zhenhua XIE, Dongguan (CN)

(73) Assignee: VIVO MOBILE COMMUNICATION CO., LTD., Dongguan (CN)

(21) Appl. No.: 19/083,404

(22) Filed: Mar. 18, 2025

Related U.S. Application Data
(63) Continuation of application No. PCT/CN2023/119668, filed on Sep. 19, 2023.

(30) Foreign Application Priority Data
Sep. 20, 2022 (CN) 202211146490.7
Dec. 14, 2022 (CN) 202211610913.6

(51) Int. Cl. H04W 76/11; H04W 8/18; H04W 48/08

(52) U.S. Cl. CPC H04W 76/11; H04W 8/186; H04W 48/08

(57) ABSTRACT

A parameter obtaining method and apparatus, a first network function, and a second network function are provided. The parameter obtaining method includes: learning, by the first network function, a configuration parameter of a target service on the basis of a first identifier or a second identifier. The configuration parameter includes at least one of the following: subscription data of the target service; application data of the target service; network data, session data or service instance data of the target service; or gateway information data of the target service. The first identifier is associated with the second identifier, and the first identifier or the second identifier is associated with one or more first communication devices.

### CROSS-REFERENCE TO RELATED APPLICATIONS

This application is a continuation of International Application No. PCT/CN2023/119668, filed on Sep. 19, 2023, which claims the priority of Chinese Patent Application No. 202211146490.7 filed on Sep. 20, 2022 and China Patent Application No. 202211610913.6 filed on Dec. 14, 2022. The entire contents of each of the above-referenced applications are expressly incorporated herein by reference.

### TECHNICAL FIELD

This application belongs to the technical field of communications, and particularly relates to a parameter obtaining method and apparatus, a first network function, and a second network function.

### BACKGROUND

In a Personal IoT Network (PIN), a PIN Element with Gateway Capability (PEGC) takes various forms. For example, it may be a gateway in a smart home scenario or a terminal that interacts with wearable devices in a wearable device scenario. The device behind the gateway may be a User Equipment (UE), such as a smart watch and a mobile phone, or a device that does not have the ability to access the wireless network directly, such as a bracelet and a headphone.

In the related art, the 5G network provides an open capability function, allowing applications to provide application parameters to the 5G network and store them in a Policy Control Function (PCF) or a Unified Data Repository (UDR), and the parameters stored in the UDR can be notified to the PCF to generate corresponding policies.

In a PIN scenario, after a user subscribes a service, the system needs to dynamically configure some parameters. Therefore, how to dynamically configure parameters for applications after the user subscribes a personal Internet service is an urgent problem to be solved for those skilled in the art.

### SUMMARY

Embodiments of this application provide a parameter obtaining method and apparatus, a first network function, and a second network function.

A first aspect provides a parameter obtaining method, including:
learning, by a first network function, a configuration parameter of a target service on the basis of a first identifier or a second identifier, where the configuration parameter includes at least one of the following:
   subscription data of the target service;
   application data of the target service;
   network data, session data or service instance data of the target service; and
   gateway information data of the target service,
   where the first identifier is associated with the second identifier, and the first identifier or the second identifier is associated with one or more first communication devices.

A second aspect provides a parameter obtaining method, including:
sending, by a second network function, a configuration parameter of a target service to a first network function on the basis of a first identifier or a second identifier, where the configuration parameter includes at least one of the following:
   subscription data of the target service;
   application data of the target service;
   network data, session data or service instance data of the target service; and
   gateway information data of the target service,
   where the first identifier is associated with the second identifier, and the first identifier or the second identifier is associated with one or more first communication devices.

A third aspect provides a parameter obtaining apparatus, including:
an obtaining module, configured to learn a configuration parameter of a target service on the basis of a first identifier or a second identifier, where the configuration parameter includes at least one of the following:
   subscription data of the target service;
   application data of the target service;
   network data, session data or service instance data of the target service; and
   gateway information data of the target service,
   where the first identifier is associated with the second identifier, and the first identifier or the second identifier is associated with one or more first communication devices.

A fourth aspect provides a parameter obtaining apparatus, including:
a sending module, configured to send a configuration parameter of a target service to a first network function on the basis of a first identifier or a second identifier, where the configuration parameter includes at least one of the following:
   subscription data of the target service;
   application data of the target service;
   network data, session data or service instance data of the target service; and
   gateway information data of the target service,
   where the first identifier is associated with the second identifier, and the first identifier or the second identifier is associated with one or more first communication devices.

A fifth aspect provides a first network function, including a processor and a memory. The memory stores a program or an instruction runnable on the processor, and the program or the instruction, when being executed by the processor, implements steps of the parameter obtaining method according to the first aspect.

A sixth aspect provides a first network function, including a processor and a communication interface. The communication interface is configured to learn a configuration parameter of a target service on the basis of a first identifier or a second identifier. The configuration parameter includes at least one of the following:
subscription data of the target service;
application data of the target service;
network data, session data or service instance data of the target service; and
gateway information data of the target service,
where the first identifier is associated with the second identifier, and the first identifier or the second identifier is associated with one or more first communication devices.

A seventh aspect provides a second network function, including a processor and a memory. The memory stores a program or an instruction runnable on the processor, and the program or the instruction, when being executed by the processor, implements steps of the parameter obtaining method according to the second aspect.

An eighth aspect provides a second network function, including a processor and a communication interface. The communication interface is configured to send a configuration parameter of a target service to a first network function on the basis of a first identifier or a second identifier. The configuration parameter includes at least one of the following:
subscription data of the target service;
application data of the target service;
network data, session data or service instance data of the target service; and
gateway information data of the target service,
where the first identifier is associated with the second identifier, and the first identifier or the second identifier is associated with one or more first communication devices.

A ninth aspect provides a parameter obtaining system, including: a first network function and a second network function. The first network function may be configured to execute steps of the method according to the first aspect. The second network function may be configured to execute steps of the method according to the second aspect.

A tenth aspect provides a readable storage medium, storing a program or an instruction therein. The program or the instruction, when being executed by a processor, implements steps of the method according to the first aspect or implements steps of the method according to the second aspect.

An eleventh aspect provides a chip, including a processor and a communication interface. The communication interface is coupled to the processor. The processor is configured to run a program or an instruction to implement steps of the method according to the first aspect or implement steps of the method according to the second aspect.

A twelfth aspect provides a computer program/program product. The computer program/program product is stored in a storage medium. The computer program/program product is executed by at least one processor to implement steps of the method according to the first aspect or implement steps of the method according to the second aspect.

In the embodiments of this application, the first network function obtains the configuration parameter of the target service of the communication device associated with the first identifier and/or the second identifier on the basis of the first identifier and/or the second identifier associated with the first identifier, and thus, the first network function can effectively support the application of the target service on the basis of the obtained configuration parameter of the target service, thereby ensuring the target service subscribed by the user to proceed normally.

### BRIEF DESCRIPTION OF THE DRAWINGS

FIG. 1 is a schematic diagram of a wireless communication system applicable to an embodiment of this application;

FIG. 2 is a schematic flowchart I of a parameter obtaining method provided by an embodiment of this application;

FIG. 3 is a schematic interactive flowchart of the parameter obtaining method provided by an embodiment of this application;

FIG. 4 is a schematic flowchart II of the parameter obtaining method provided by an embodiment of this application;

FIG. 5 is a schematic structural diagram I of a parameter obtaining apparatus provided by an embodiment of this application;

FIG. 6 is a schematic structural diagram II of the parameter obtaining apparatus provided by an embodiment of this application;

FIG. 7 is a schematic structural diagram of a communication device provided by an embodiment of this application; and

FIG. 8 is a schematic structural diagram of a network side device provided by an embodiment of this application.

### DETAILED DESCRIPTION

The technical solutions in embodiments of this application are described in the following with reference to the accompanying drawings in the embodiments of this application. Apparently, the described embodiments are merely some rather than all of the embodiments of this application. All other embodiments obtained by persons skilled in the art based on the embodiments of this application fall within the protection scope of this application.

Terms such as “first” and “second” in the description and claims of this application are used to distinguish similar objects, but are unnecessarily used to describe a specific sequence or order. It should be understood that the terms used in this way are exchangeable in a proper case, so that the embodiments of this application can be implemented in an order different from the order shown or described herein, and the objects distinguished by “first” and “second” are usually of the same type, and there is no limit to the number of the objects, for example, there may be one or more first objects. In addition, “and/or” used in this description and the claims represents at least one of the connected objects. The character “/” generally indicates an “or” relationship between the objects associated before and after.

It is worth pointing out that the technologies described in this application may be applied not only to a Long Term Evolution (LTE)/LTE-Advanced (LTE-A) system, but also to various wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA) and other systems. The terms “system” and “network” in the embodiments of this application are often used interchangeably, and the technologies described may be used not only for the above-mentioned systems and radio technologies, but also for other systems and radio technologies. The following description describes a New Radio (NR) system for exemplary purposes, and NR terminology is used in most of the following descriptions, but these technologies may also be applied to applications other than NR system applications, such as 6^{th} Generation (6G) communication systems.

### PIN

A PIN is a group including at least one PIN Element (PINE), in which at least one PIN element is a terminal (e.g., UE). The PIN elements communicate with each other. Two PIN elements can communicate through a direct connection therebetween or indirectly through a communication network.

A PIN element may be a 3GPP device (such as UE) or a non-3GPP device. The non-3GPP device refers to a device that does not use 3GPP-defined credentials, a device that does not support a 3GPP-defined NAS protocol, or a device that does not support 3GPP access technologies (such as 3G/4G/5G air interface technologies) but only supports non-3GPP access technologies (such as WiFi, fixed-line, Bluetooth and other access technologies).

A PIN may have one or more PEGCs. The PIN elements in the PIN can communicate with each other directly or through the PEGC. The PIN elements in the PIN can communicate with other devices or application servers outside the PIN through the PEGC. PEGC devices may be different types of devices. For example, the PEGC may be a gateway in a smart home scenario or a mobile phone as a gateway of a wearable device in a wearable device scenario.

FIG. 1 is a schematic diagram of a wireless communication system applicable to an embodiment of this application. The wireless communication system shown in FIG. 1 includes a terminal 11 and a network side device 12. The terminal 11 may be a mobile phone, a tablet personal computer, a laptop computer or notebook computer, a Personal Digital Assistant (PDA), a palm computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (home devices with a wireless communication function, such as a refrigerator, a television, a washing machine or furniture), a game machine, a Personal Computer (PC), a teller machine, a self-service machine and other terminal side devices. The wearable device includes a smart watch, a smart bracelet, smart headphones, smart glasses, smart jewelry (a smart bangle bracelet, a smart chain bracelet, a smart ring, a smart necklace, a smart bangle anklet, a smart chain anklet, etc.), a smart wristband, smart clothes, etc. It should be noted that the specific type of the terminal 11 is not limited in the embodiments of this application.

The network side device 12 may include an access network device or a core network device. The access network device may also be called a radio access network device, a Radio Access Network (RAN), a radio access network function or a radio access network unit. The access network device may include a base station, a WLAN access point, a WiFi node or the like. The base station may be called a node B, an evolved Node B (eNB), an access point, a Base Transceiver Station (BTS), a radio base station, a radio transceiver, a Basic Service Set (BSS), an Extended Service Set (ESS), a home node B, a home evolved node B, a Transmission and Reception Point (TRP) or some other appropriate terms in the art. The base station is not limited to a specific technical vocabulary as long as the same technical effect is achieved. It should be noted that in the embodiments of this application, only the base station in the NR system is introduced as an example, and the specific type of the base station is not limited. The core network device may include, but not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), a Location Manage Function (LMF), an Enhanced Serving Mobile Location Centre (E-SMLC), a Network Data Analytics Function (NWDAF) and the like. It should be noted that in the embodiments of this application, only the core network device in the NR system is introduced as an example, and the specific type of the core network device is not limited.

A parameter obtaining method provided by an embodiment of this application will be described in detail below in conjunction with the accompanying drawings and through some embodiments and application scenarios thereof.

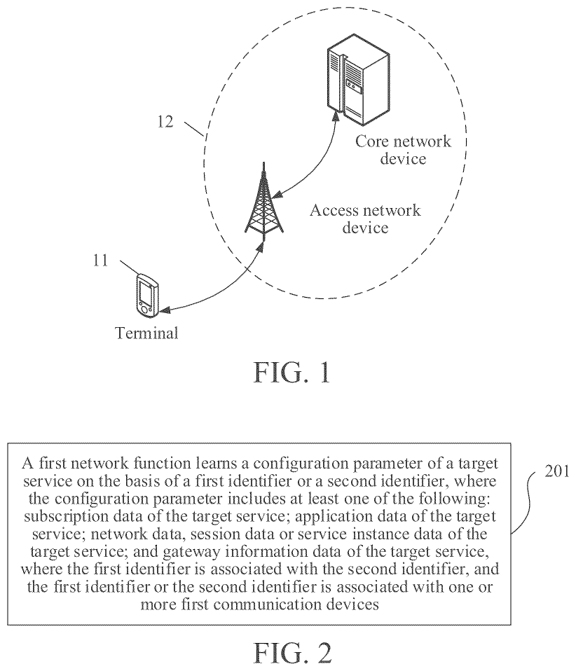

FIG. 2 is a schematic flowchart I of the parameter obtaining method provided by an embodiment of this application. As shown in FIG. 2, the method includes:
Step 201: Learn, by a first network function, a configuration parameter of a target service on the basis of a first identifier or a second identifier, where the configuration parameter includes at least one of the following:
   subscription data of the target service;
   application data of the target service;
   network data, session data or service instance data of the target service; and
   gateway information data of the target service,
   where the first identifier is associated with the second identifier, and the first identifier or the second identifier is associated with one or more first communication devices.

For example, after the user subscribes the target service, the first network function may obtain the configuration parameter of the target service on the basis of the first identifier or the second identifier, and thus, the first network function can effectively support the application of the target service on the basis of the obtained configuration parameter of the target service, thereby ensuring the target service subscribed by the user to proceed normally. In some embodiments, the target service may be a PIN service, and the first network function may be a PCF and/or an NEF. In some embodiments, the first identifier is associated with the second identifier, and the first identifier or the second identifier is associated with one or more of first communication devices, so that the first network function can accurately obtain the configuration parameter of the target service corresponding to the communication device associated with the first identifier and/or the second identifier on the basis of the association relationship between the first identifier and/or the second identifier and the first communication device. The communication device may be a PEGC and PIN Management Terminal (PEMC), and the configuration parameter includes at least one of the following: subscription data, application data, network data, gateway information data, session data or service instance data.

For example, after the first network function sends the first identifier to a second network function UDR and the second network function receives the first identifier sent by the first network function, the second network function sends PIN application data to the first network function on the basis of the first identifier, and a first network obtains the PIN application data from the second network function UDR.

In some embodiments, the first communication device may be a target UE having an association relationship with a Generic Public Subscription Identifier (GPSI), for example, can map the GPSI in Target UE Identifier into SUPI, according to information received from UDM.

In some embodiments, the learning a configuration parameter of a target service in step 201 may be receiving relevant information about data changes from the UDR, for example, receive Nudr_DM_Notify notification from the UDR.

In some embodiments, the first identifier may be an internal PIN subscription identifier, which is used between functions inside the 5G system to associate the parameter of the PIN service, and the first network function may use the first identifier to learn the parameter of the PIN service from the second network function UDR, such as one of Subscription Permanent Identifiers (SUPIs) in users represented by GPSIs. The second identifier is an external PIN subscription identifier, which is used outside the 5G system to hide the internal PIN subscription identifier, such as one of the GPSIs. When there is no need to hide the internal PIN subscription identifier, the external PIN subscription identifier is not needed. In some embodiments, the first network function may use the first identifier and the second identifier respectively inside the 5G system and outside the 5G system to improve the communication security, and may also use the first identifier or the second identifier both inside the 5G system and outside the 5G system to improve the efficiency.

In some embodiments, the first identifier includes at least one of the following: SUPI; PDU session information; a network identifier, a session identifier or a service instance identifier of the target service; and an identifier of the first communication device.

In some embodiments, the second identifier includes at least one of the following: the identifier of the first communication device; and the GPSI.

According to the parameter obtaining method provided by this embodiment of this application, after the first network function obtains the configuration parameter of the target service of the communication device associated with the first identifier and/or the second identifier on the basis of the first identifier and/or the second identifier associated with the first identifier, the first network function can obtain the configuration parameter of the target service, and thus, the first network function can effectively support the application of the target service on the basis of the obtained configuration parameter of the target service, thereby ensuring the target service subscribed by the user to proceed normally.

In an embodiment, the subscription data may include at least one of the following:
a) the first identifier, used for associating the subscription data;
b) the second identifier associated with the first identifier, used for associating the subscription data;
c) protocol data unit PDU session information, used for indicating a PDU session, where the PDU session is used for transmission of a control message of the target service;
d) a quantity of networks, a quantity of sessions or a quantity of service instances of the target service, used for indicating the quantity of allowed networks, sessions or service instances of the target service; and
e) first indication information, used for indicating a network function that allows requesting a target network to control the target service.

The first identifier and the second identifier associated with the first identifier are used for associating the subscription data. For example, in a case that the fifth network function is an AF, the fifth network function associates the first identifier and/or the second identifier with the subscription data, so that the subscription data can be accurately obtained on the basis of the association relationship between the first identifier and/or the second identifier and the subscription data, thereby ensuring the target service subscribed by the user to proceed normally. In some embodiments, the first indication information may be used for indicating a network function that allows requesting a 5G network to control the target service. In some embodiments, the quantity of networks of the target services is used for indicating a quantity of networks that are allowed to be created. The first indication information is used for indicating an application function that allows sending the configuration parameter of the related PIN service to the 5G network.

In an embodiment, the application data includes at least one of the following:
a) the first identifier, used for associating the application data or subscription data associated with the application data;
b) the second identifier associated with the first identifier, used for associating the application data or subscription data associated with the application data;
c) the network identifier, the session identifier or the service instance identifier of the target service;
d) PDU session information, used for indicating a PDU session, where the PDU session is used for a network or a session or a service instance of the target service;
e) a quantity of networks, a quantity of sessions or a quantity of service instances of the target service, used for indicating the quantity of existing or created networks, sessions or service instances of the target service;
f) a subnet address, used for indicating subnet address information of the target service; and
g) a subnet mask, used for indicating subnet mask information of the target service.

In some embodiments, the network identifier of the target service may be a DNN and/or an S-NSSAI allocated for the PIN.

For example, the first identifier and the second identifier associated with the first identifier are used for associating the application data or subscription data associated with the application data. For example, in a case that the fifth network function is an AF, the fifth network function associates the first identifier and/or the second identifier with the application data, so that the application data can be accurately obtained on the basis of the association relationship between the first identifier and/or the second identifier and the application data, thereby ensuring the target service subscribed by the user to proceed normally.

In an embodiment, the network data, the session data or the service instance data includes at least one of the following:
1) the first identifier, used for associating the network data, the session data or the service instance data;
2) the second identifier associated with the first identifier, used for associating the network data, the session data or the service instance data;
3) the network identifier, the session identifier or the service instance identifier of the target service;
4) PDU session information, used for indicating a PDU session, where the PDU session is used for a network or a session or a service instance of the target service;
5) allowed Quality of Service (QoS) information, used for indicating QoS information allowed by a target network for data in the network or the session or the service instance;
6) second indication information, used for indicating at least one of the PDU session, the network, the session and the service instance, to transmit or not transmit a control message of the target service, or to transmit only or not only a data message of the target service; and
7) a default maximum quantity of connectable devices of the first communication device, used for determining an address range or an address range size sent to the first communication device.

The first identifier and the second identifier associated with the first identifier are used for associating the network data, the session data or the service instance data. For example, in a case that the fifth network function is an AF, the fifth network function associates the first identifier and/or the second identifier with the network data, the session data or the service instance data, so that the network data, the session data or the service instance data can be accurately obtained on the basis of the association relationship between the first identifier and/or the second identifier and the network data, the session data or the service instance data, thereby ensuring the target service subscribed by the user to proceed normally. In some embodiments, the allowed QoS information is used for indicating QoS information allowed and supported by a 5G network for data of the corresponding network, such as allowed data transmission delay budget, data transmission bandwidth and other information. In some embodiments, the maximum quantity of connectable devices of the first communication device is used for indicating the IP range that the 5G network decides for the communication device PEGC, and the PEGC allocates the IP address for the connected device on the basis of the IP address range.

In an embodiment, the gateway information data includes at least one of the following:
a) the first identifier, used for associating the gateway information data;
b) the second identifier associated with the first identifier, used for associating the gateway information data;
c) the identifier of the first communication device;
d) a maximum quantity of connectable devices of the first communication device, used for determining an address range or an address range size sent to the first communication device;
e) QoS information of the first communication device, used for indicating non-3GPP access QoS information of the first communication device; and
f) identification information, used for identifying a control message of the target service sent to the first communication device or a control message of the target service sent by the first communication device.

The first identifier and the second identifier associated with the first identifier are used for associating the gateway information data. For example, in a case that the third network function is an SMF, the third network function associates the first identifier and/or the second identifier with the gateway information data, so that the gateway information data can be accurately obtained on the basis of the association relationship between the first identifier and/or the second identifier and the gateway information data, thereby ensuring the target service subscribed by the user to proceed normally.

In an embodiment, the learning, by a first network function, a configuration parameter of a target service on the basis of a first identifier includes:
obtaining, by the first network function, the configuration parameter of the target service from a second network function on the basis of the first identifier.

For example, the first network function may be a PCF, the second network function may be a UDR, and the first identifier includes at least one of the following: the SUPI, the PDU session information, the network identifier, the session identifier or the service instance identifier of the target service, and the identifier of the first communication device. That is, the first network function can accurately obtain the configuration parameter of the target service from the second network function on the basis of the first identifier, and thus, can effectively support the application of the target service on the basis of the obtained configuration parameter of the target service, thereby effectively ensuring the target service subscribed by the user to proceed normally.

For example, the first network function learns PIN application data from the second network function UDR on the basis of the internal PIN subscription identifier, where the PIN application data is associated with the above-mentioned internal PIN subscription identifier. In some embodiments, after the first network function sends the internal PIN subscription identifier to the second network function UDR and the second network function UDR receives the internal PIN subscription identifier sent by the first network function, the second network function sends the PIN application data to the first network function on the basis of the internal PIN subscription identifier, so that the first network obtains the PIN application data from the second network function.

In an embodiment, the obtaining, by the first network function, the configuration parameter of the target service from a second network function on the basis of the first identifier includes:
invoking, by the first network function, a subscription operation from the second network function, where a parameter of the subscription operation includes the first identifier;
receiving, by the first network function, an event identifier of the subscription operation sent by the second network function;
associating, by the first network function, the event identifier with the first identifier, or associating the event identifier with the one or more first communication devices associated with the first identifier; and
receiving, by the first network function, the event identifier sent by the second network function and the configuration parameter of the target service.

For example, the first network function may invoke the subscription operation including the first identifier from the second network function, and the second network function receives a subscription request carrying the first identifier sent by the first network function and sends the event identifier to the first network function. After receiving the event identifier of the subscription operation sent by the second network function, the first network function associates the event identifier with the first identifier or associates the event identifier with the one or more first communication devices associated with the first identifier, and thus, the first network function can accurately and effectively obtain the configuration parameter of the target service on the basis of the event identifier sent by the second network function.

For example, the first network function subscribes an event related to the internal PIN subscription identifier from the second network function UDR, where the event is used for the second network function UDR to notify the first network function when the PIN application data associated with the internal PIN subscription identifier changes. For example, when the PIN application data changes, the second network function sends the updated PIN application data and the event identifier to the first network function. In some embodiments, the subscription is also associated with the user terminal identifier, i.e., the first network function receives the event identifier sent by the second network function UDR and associates the event identifier with the terminal identifier.

In the method of the embodiment above, the first network function receives the event identifier of the subscription operation sent by the second network function, and associates the event identifier with the first identifier or associates the event identifier with the one or more first communication devices associated with the first identifier, so that the first network function can accurately and effectively obtain the configuration parameter of the target service on the basis of the event identifier sent by the second network function.

In an embodiment, the obtaining, by the first network function, the configuration parameter of the target service from a second network function on the basis of the first identifier includes:
invoking, by the first network function, a subscription operation from the second network function for the first communication device, where a parameter of the subscription operation includes the first identifier;
receiving, by the first network function, an event identifier of the subscription operation sent by the second network function;
associating, by the first network function, the event identifier with the first communication device; and
receiving, by the first network function, the event identifier sent by the second network function and the configuration parameter of the target service.

For example, the first network function may invoke the subscription operation including the first identifier from the second network function, and the second network function sends the event identifier of the subscription operation to the first network function on the basis of the subscription operation including the first identifier. After receiving the event identifier of the subscription operation sent by the second network function, the first network function associates the event identifier with the first communication device, and thus, the first network function can accurately and effectively obtain the configuration parameter of the target service on the basis of the event identifier sent by the second network function.

For example, in an example where the first network function is a PCF, the first network function subscribes an event from the second network function UDR for the SUPI of the communication device PEMC on the basis of the PIN subscription identifier of the communication device PEMC. For example, the first network function sends a PIN subscription identifier to the second network function UDR for the SUPI of the PEMC, the second network function UDR returns the event identifier, and the first network function associates the event identifier with the SUPI, so that the configuration parameter of the target service can be accurately and effectively obtained.

In the method of the embodiment above, the first network function receives the event identifier of the subscription operation sent by the second network function, and associates the event identifier with the first communication device, so that the first network function can accurately and effectively obtain the configuration parameter of the target service on the basis of the event identifier sent by the second network function.

In an embodiment, in a case that the configuration parameter includes the application data, the method further includes:
sending, by the first network function, a UE Route Selection Policy (URSP) to the first communication device on the basis of the application data.

In an example where the first network function is a PCF, the second network function UDR sends PIN application data to the first network function, where the PIN application data is used for generating the URSP by the first network function on the basis of the PIN application data. The URSP is used to be sent to the terminal so that the terminal establishes a PDU session according to the URSP, and the PDU session is used for supporting transmission of data and signaling of the related PIN service, such as a data network name DNN and single network slice selection assistance information S-NSSAI.

In some embodiments, the PCF may generate URSP rules according to the PIN ID. In some embodiments, after generating the URSP rules, the PCF may further trigger UE policy delivery.

In some embodiments, after obtaining the personal IOT application data from the second network function UDR on the basis of the first identifier, the first network function generates the URSP on the basis of the obtained application data and sends the URSP to the first communication device so as to support the application of the IOT service, so that the first communication device can carry out the IOT service normally on the basis of the received URSP. In some embodiments, the PIN application data includes at least one of the following: the network identifier of the target service, and the mapping between the network identifier of the target service and the PDU session information.

For example, on the basis of the subscription, the second network function UDR sends corresponding data and the event identifier to the first network function PCF when the PIN application data and/or PIN authorization data corresponding to the PIN subscription identifier changes, and the first network function PCF generates the URSP for the corresponding SUPI on the basis of the received data and event identifier.

In an embodiment, the parameter obtaining method further includes at least one of the following:
sending, by the first network function, the network data, the session data or the service instance data to a third network function;
determining, by the first network function, whether QoS requested by the first communication device is met or not on the basis of the allowed QoS information included in the network data, the session data or the service instance data; and
sending, by the first network function, IP address range information to the third network function on the basis of the default maximum quantity of connectable devices of the first communication device included in the network data, the session data or the service instance data.

For example, after learning the configuration parameter of the target service on the basis of the first identifier or the second identifier, the first network function can send the network data, the session data or the service instance data to the third network function. In some embodiments, the third network function may be an SMF. In some embodiments, the first network function may also send the IP address range information to the third network function SMF on the basis of the default maximum quantity of connectable devices of the first communication device included in the network data, the session data or the service instance data, so that the third network function SMF can allocate the IP address range for the first communication device on the basis of the maximum quantity of connectable devices of each first communication device and send the IP address range to the first communication device.

For example, the first network function learns the maximum quantity of connectable devices of each communication device PEGC from the second network function UDR, generates the IP address range on the basis of the maximum quantity information and sends the IP address range to the third network function SMF. In some embodiments, after the first network function sends the PDU session information or the network identifier to the second network function and the second network function UDR receives the PDU session information or the network identifier sent by the first network function, the maximum quantity of connectable devices of each communication device PEGC can be sent to the first network function on the basis of the PDU session information or the network identifier, so that the first network function can learn the maximum quantity of connectable devices of each communication device PEGC from the second network function UDR. In some embodiments, the PDU session information includes at least one of the following: a data network name DNN, single network slice selection assistance information S-NSSAI, a PDU session identifier ID, and an identifier of a user terminal to which the PDU session belongs.

In an embodiment, the parameter obtaining method further includes at least one of the following:
sending, by the first network function, the gateway information data to a third network function; and
sending, by the first network function, IP address range information to the third network function on the basis of the maximum quantity of connectable devices of the first communication device included in the gateway information data.

For example, after the first network function learns the configuration parameter of the target service on the basis of the first identifier or the second identifier, the first network function may send the gateway information data in the obtained configuration parameter to the third network. The first network function may also send the IP address range information to the third network function on the basis of the maximum quantity of connectable devices of the first communication device included in the obtained network information data, so that the third network function SMF can send the obtained IP address range to the first communication device.

For example, in an example where the first network function is a PCF, the second network function UDR sends the maximum quantity of connectable devices of each communication device PEGC to the first network function, so that the first network function can send the maximum quantity of connectable devices of each communication device PEGC to the third network function SMF or the first network function can generate the IP address range on the basis of the maximum quantity of connectable devices of each communication device PEGC and send the IP address range to the SMF. That is, after learning the maximum quantity of connectable devices of each communication device PEGC from the second network function UDR, the first network function sends the maximum quantity information to the third network function SMF, or generates the IP address range on the basis of the maximum quantity information and sends the IP address range to the third network function.

In an embodiment, before the learning, by a first network function, a configuration parameter of a target service on the basis of a first identifier or a second identifier, the method further includes:
receiving, by the first network function, a service parameter for the first identifier or the second identifier.

In some embodiments, in an example where the first network function is a NEF, before the first network function learns the configuration parameter of the target service on the basis of the first identifier or the second identifier, the first network function receives a service parameter for the first identifier or the second identifier. In some embodiments, the service parameter includes at least one of the following:
1) the network identifier, the session identifier or the service instance identifier of the target service;
2) the PDU session information;
3) service operation information, including any one of a create operation, an add operation, a release operation, a delete operation and an update operation;
4) the identifier of the first communication device;
5) the maximum quantity of connectable devices of the first communication device;
6) the QoS information of the first communication device, used for indicating the non-3GPP access QoS information of the first communication device; and
7) the identification information, used for identifying the control message of the target service sent to the first communication device or the control message of the target service sent by the first communication device.

For example, in an example where the first network function is a NEF, the first network function receives the PIN service parameter sent by the AF and sends the PIN application data and/or the maximum quantity of connectable devices of each communication device PEGC to the second network device UDR on the basis of the PIN service parameter. In some embodiments, the PIN application data includes at least one of the following: the network identifier of the target service, and the mapping between the network identifier of the target service and the PDU session information.

In an embodiment, after the learning, by a first network function, a configuration parameter of a target service on the basis of a first identifier or a second identifier, the method further includes at least one of the following:
sending, by the first network function, the service parameter to the second network function on the basis of the subscription data; and
sending, by the first network function, the service parameter to the second network function on the basis of the application data.

In some embodiments, in an example where the first network function is a NEF, after the first network function learns the configuration parameter of the target service on the basis of the first identifier or the second identifier, the first network function may send the service parameter to the second network function UDR on the basis of the subscription data in the configuration parameter. The first network function may also send the service parameter to the second network function UDR on the basis of the application data in the configuration parameter.

For example, for creating/adding a network, the first network function updates the PIN application data and the PIN authorization data to the second network function UDR on the basis of the PIN subscription data.

In an embodiment, after the learning, by a first network function, a configuration parameter of a target service on the basis of a first identifier or a second identifier, the method further includes at least one of the following:
determining, by the first network function, to send the service parameter to the second network function on the basis of the subscription data; and
determining, by the first network function, to send the service parameter to the second network function on the basis of the application data.

For example, in an example where the first network function is a NEF, the first network function obtains the corresponding PIN subscription data from the second network function UDR on the basis of the external/internal PIN subscription identifier, determines whether the AF can send the service parameter to the second network function on the basis of the AF information subscribed in the PIN subscription data, and if not, stops sending the service parameter to the second network function.

For creating/adding a network, the first network function determines whether a quantity of networks exceeds a limit on the basis of the PIN subscription data, and if so, stops sending the service parameter to the second network function UDR; and if not, the first network function updates the PIN application data and the PIN authorization data to the second network function UDR on the basis of the PIN subscription data.

In an embodiment, the sending, by the first network function, the service parameter to the second network function on the basis of the subscription data includes at least one of the following:
in a case that the service parameter indicates creating the network, the session or the service instance of the target service, sending, by the first network function, the service parameter to the second network function on the basis of the quantity of networks, the quantity of sessions or the quantity of service instances of the target service included in the subscription data; and
sending, by the first network function, the service parameter to the second network function on the basis of the first indication information included in the subscription data.

In an example where the first network function is a NEF, in a case that the service parameter indicates creating the network, the session or the service instance of the target service, the first network function may send the service parameter to the second network function on the basis of the quantity of networks, the quantity of sessions or the quantity of service instances of the target service included in the subscription data; and/or the first network function may send the service parameter to the second network function on the basis of the first indication information included in the subscription data. The first indication information is used for indicating a network function that allows requesting a target network to control the target service.

In an embodiment, the sending, by the first network function, the service parameter to the second network function on the basis of the application data includes:
in a case that the service parameter indicates creating the network, the session or the service instance of the target service, sending, by the first network function, the service parameter to the second network function on the basis of a quantity of records of the application data.

In an example where the first network function is a NEF, in a case that the service parameter indicates creating the network, the session or the service instance of the target service, the first network function may send the service parameter to the second network function on the basis of the quantity of existing networks.

In an embodiment, the first network function sends the PDU session information in the application data and the PDU session information in the network data, the session data or the service instance data to the second network function on the basis of the service parameter.

In some embodiments, the PDU session information includes at least one of the following:
a data network name DNN;
single network slice selection assistance information S-NSSAI;
a PDU session identifier ID; and
an identifier of a user terminal to which the PDU session belongs.

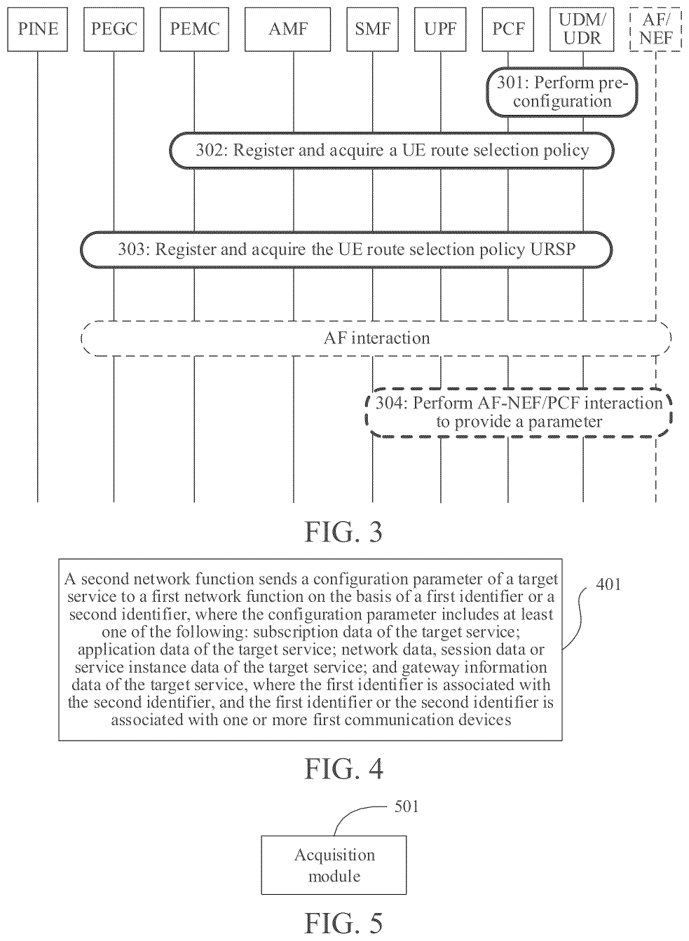

FIG. 3 is a schematic interactive flowchart of the parameter obtaining method provided by an embodiment of this application. The interactive flow of the parameter obtaining method provided by this embodiment includes:
Step 301: Perform pre-configuration, i.e., the user subscribes a PIN service with an operator, which includes one or more GPSIs and may also include one or more predefined networks.

According to the subscription, the operator pre-configures the following information for a terminal user represented by each GPSI:
a) a UE route selection policy URSP related to the predefined network; and
b) an internal PIN subscription identifier.

According to the subscription, the operator pre-configures PIN subscription data in the UDR:
a) an external PIN subscription identifier;
b) an internal PIN subscription identifier;
c) PDU session information;
d) a quantity of networks of the target services, i.e., a quantity of subscribed networks, used for indicating a quantity of networks that are allowed to be created; and
e) first indication information, i.e., subscribed AF information, used for indicating a network function that allows requesting a target network to control the target service.

The UDR may store the following PIN application data:
a) the internal PIN subscription identifier; and
b) the PDU session information.

The UDR may also store the following PIN authorization data:
a) the PDU session information;
b) allowed QoS information; and
c) a default maximum quantity of connectable devices of the first communication device, i.e., a maximum quantity of connectable devices of each PIN gateway PEGC.

Step 302: Register and obtain the UE route selection policy, i.e., the PEMC is registered into the 5G system. During the registration process, the PCF subscribes an event from the UDR for the SUPI of the PEMC on the basis of the PIN subscription identifier of the PEMC, for example, the PCF sends the PIN subscription identifier to the UDR for the SUPI of the PEMC, the UDR returns the event identifier, and the PCF associates the event identifier with the SUPI. On the basis of the subscription, the UDR sends corresponding data and the event identifier to the PCF when the PIN application data and/or PIN authorization data corresponding to the PIN subscription identifier changes, and the PCF generates the URSP for the corresponding SUPI on the basis of the received data and event identifier.

Step 303: Register and obtain the UE route selection policy URSP, i.e., the PIN gateway PEGC of the user executes the same process as step 302.

Step 304: Perform AF-NEF/PCF interaction to provide a parameter, i.e., the AF receives a request of the PEMC or the PEGC and sends a PIN management parameter to the NEF, where the PIN management parameter includes the following information:
a) the external/internal PIN subscription identifier;
b) the PDU session information.
c) service operation information, including creating/adding a network, releasing/deleting a network, and updating a network;
d) the allowed QoS information; and
e) the maximum quantity of connectable devices of each PEGC. In some embodiments, the information can only be carried when creating/adding a network.

The NEF obtains the corresponding PIN subscription data from the UDR on the basis of the external/internal PIN subscription identifier, determines whether the AF can execute the above operations on the basis of the subscribed AF information in the PIN subscription data, and if not, stops the process.

For creating/adding a network, the NEF determines whether a quantity of networks exceeds a limit on the basis of the PIN subscription data, and if so, stops the process. The NEF updates the PIN application data and the PIN authorization data to the UDR on the basis of the above data. On the basis of the subscription, the UDR sends update information to the PCF, and the PCF updates the URSP on the basis of the above information and sends the updated URSP to the corresponding terminal. The PCF learns the PIN authorization data from the UDR on the basis of the network ID and sends the PIN authorization data to the SMF, or determines whether the QoS requested by the PEGC/PEMC is acceptable on the basis of the PIN authorization data, and the SMF allocates the IP range for the PEGC on the basis of the maximum quantity of connectable devices of each PIN gateway PEGC and sends the IP range to the PEGC.

Through the above related configuration and process, when the user requests the AF to create or delete the PIN network through the PEMC, the URSP is updated, and the PCF sends the updated URSP to each PEGC and PEMC that make up the network, so that the PEMCs/PEGCs establish or release the corresponding PDU session for supporting the PIN network.

FIG. 4 is a schematic flowchart II of the parameter obtaining method provided by an embodiment of this application. As shown in FIG. 4, the parameter obtaining method provided by this embodiment includes:
Step 401: Send, by a second network function, a configuration parameter of a target service to a first network function on the basis of a first identifier or a second identifier, where the configuration parameter includes at least one of the following:
   subscription data of the target service;
   application data of the target service;
   network data, session data or service instance data of the target service; and
   gateway information data of the target service.

The first identifier is associated with the second identifier, and the first identifier or the second identifier is associated with one or more first communication devices.

In some embodiments, the subscription data includes at least one of the following:
the first identifier, used for associating the subscription data;
the second identifier associated with the first identifier, used for associating the subscription data;
protocol data unit PDU session information, used for indicating a PDU session, where the PDU session is used for transmission of a control message of the target service;
a quantity of networks, a quantity of sessions or a quantity of service instances of the target service, used for indicating the quantity of networks, sessions or service instances of the target service that are allowed to be created; and
first indication information, used for indicating a network function that allows requesting a target network to control the target service.

In some embodiments, the application data includes at least one of the following:
the first identifier, used for associating the application data or subscription data associated with the application data;
the second identifier associated with the first identifier, used for associating the application data or subscription data associated with the application data;
a network identifier, a session identifier or a service instance identifier of the target service;
PDU session information, used for indicating a PDU session, where the PDU session is used for carrying a network or a session or a service instance of the target service;
a quantity of networks, a quantity of sessions or a quantity of service instances of the target service, used for indicating the quantity of existing or created networks, sessions or service instances of the target service;
a subnet address, used for indicating subnet address information of the target service; and
a subnet mask, used for indicating subnet mask information of the target service.

In some embodiments, the network data, the session data or the service instance data includes at least one of the following:
the first identifier, used for associating the network data, the session data or the service instance data;
the second identifier associated with the first identifier, used for associating the network data, the session data or the service instance data;
a network identifier, a session identifier or a service instance identifier of the target service;
PDU session information, used for indicating a PDU session, where the PDU session is used for carrying a network or a session or a service instance of the target service;
allowed QoS information, used for indicating QoS information allowed and supported by a target network for data in the network or the session or the service instance;
second indication information, used for indicating at least one of the PDU session, the network, the session and the service instance, to transmit or not transmit a control message of the target service, or to transmit only or not only a data message of the target service; and
a default maximum quantity of connectable devices of the first communication device, used for determining an address range or an address range size sent to the first communication device.

In some embodiments, the gateway information data includes at least one of the following:
the first identifier, used for associating the gateway information data;
the second identifier associated with the first identifier, used for associating the gateway information data;
the identifier of the first communication device;
a maximum quantity of connectable devices of the first communication device, used for determining an address range or an address range size sent to the first communication device;
QoS information of the first communication device, used for indicating non-3GPP access QoS information of the first communication device; and
identification information, used for identifying a control message of the target service sent to the first communication device or a control message of the target service sent by the first communication device.

In some embodiments, the first identifier includes at least one of the following: a subscription permanent identifier SUPI; the PDU session information; the network identifier, the session identifier or the service instance identifier of the target service; and the identifier of the first communication device.

The second identifier includes at least one of the following: the identifier of the first communication device; and a generic public subscription identifier GPSI.

In some embodiments, the sending, by a second network function, a configuration parameter of a target service to a first network function on the basis of a first identifier or a second identifier includes:
receiving, by the second network function, invoking a subscription operation of the first network function, where a parameter of the subscription operation includes the first identifier;
sending, by the second network function, an event identifier of the subscription operation to the first network function; and
in a case that the configuration parameter of the target service changes, sending, by the second network function, the event identifier and the configuration parameter of the target service to the first network function.

In some embodiments, the parameter obtaining method further includes:
receiving, by the second network function, a service parameter sent by the first network function.

In some embodiments, the parameter obtaining method further includes:
receiving, by the second network function, the PDU session information in the application data and the PDU session information in the network data, the session data or the service instance data sent by the first network function.

In some embodiments, the service parameter includes at least one of the following:
the network identifier, the session identifier or the service instance identifier of the target service;
the PDU session information;
service operation information, including any one of a create operation, an add operation, a release operation, a delete operation and an update operation;
the identifier of the first communication device;
the maximum quantity of connectable devices of the first communication device;
the QoS information of the first communication device, used for indicating the non-3GPP access QoS information of the first communication device; and
the identification information, used for identifying the control message of the target service sent to the first communication device or the control message of the target service sent by the first communication device.

In some embodiments, the PDU session information includes at least one of the following:
a data network name DNN;
single network slice selection assistance information S-NSSAI;
a PDU session identifier ID; and
an identifier of a user terminal to which the PDU session belongs.

According to the parameter obtaining method provided by this embodiment of this application, the execution subject may be a parameter obtaining apparatus. This embodiment of this application describes the parameter obtaining apparatus provided by an embodiment of this application in an example where the parameter obtaining apparatus executes the parameter obtaining method.

FIG. 5 is a schematic structural diagram I of a parameter obtaining apparatus provided by an embodiment of this application. As shown in FIG. 5, the parameter obtaining apparatus includes:
an obtaining module 501, configured to learn a configuration parameter of a target service on the basis of a first identifier or a second identifier, where the configuration parameter includes at least one of the following:
   subscription data of the target service;
   application data of the target service;
   network data, session data or service instance data of the target service; and
   gateway information data of the target service.

The first identifier is associated with the second identifier, and the first identifier or the second identifier is associated with one or more first communication devices.

In some embodiments, the subscription data includes at least one of the following:
the first identifier, used for associating the subscription data;
the second identifier associated with the first identifier, used for associating the subscription data;
protocol data unit PDU session information, used for indicating a PDU session, where the PDU session is used for transmission of a control message of the target service;
a quantity of networks, a quantity of sessions or a quantity of service instances of the target service, used for indicating the quantity of allowed networks, sessions or service instances of the target service; and
first indication information, used for indicating a network function that allows requesting a target network to control the target service.

In some embodiments, the application data includes at least one of the following:
the first identifier, used for associating the application data or subscription data associated with the application data;
the second identifier associated with the first identifier, used for associating the application data or subscription data associated with the application data;
a network identifier, a session identifier or a service instance identifier of the target service;
PDU session information, used for indicating a PDU session, where the PDU session is used for a network or a session or a service instance of the target service;
a quantity of networks, a quantity of sessions or a quantity of service instances of the target service, used for indicating the quantity of existing or created networks, sessions or service instances of the target service;
a subnet address, used for indicating subnet address information of the target service; and
a subnet mask, used for indicating subnet mask information of the target service.

In some embodiments, the network data, the session data or the service instance data includes at least one of the following:
the first identifier, used for associating the network data, the session data or the service instance data;
the second identifier associated with the first identifier, used for associating the network data, the session data or the service instance data;
a network identifier, a session identifier or a service instance identifier of the target service;
PDU session information, used for indicating a PDU session, where the PDU session is used for a network or a session or a service instance of the target service;
allowed QoS information, used for indicating QoS information allowed by a target network for data in the network or the session or the service instance;
second indication information, used for indicating at least one of the PDU session, the network, the session and the service instance, to transmit or not transmit a control message of the target service, or to transmit only or not only a data message of the target service; and
a default maximum quantity of connectable devices of the first communication device, used for determining an address range or an address range size sent to the first communication device.

In some embodiments, the gateway information data includes at least one of the following:
the first identifier, used for associating the gateway information data;
the second identifier associated with the first identifier, used for associating the gateway information data;
an identifier of the first communication device;
a maximum quantity of connectable devices of the first communication device, used for determining an address range or an address range size sent to the first communication device;
QoS information of the first communication device, used for indicating non-3GPP access QoS information of the first communication device; and
identification information, used for identifying a control message of the target service sent to the first communication device or a control message of the target service sent by the first communication device.

In some embodiments, the first identifier includes at least one of the following: a subscription permanent identifier SUPI; the PDU session information; the network identifier, the session identifier or the service instance identifier of the target service; and the identifier of the first communication device.

The second identifier includes at least one of the following: the identifier of the first communication device; and a generic public subscription identifier GPSI.

In some embodiments, the obtaining module 501 is configured to obtain the configuration parameter of the target service from the second network function on the basis of the first identifier.

In some embodiments, the obtaining module 501 is configured to invoke a subscription operation from the second network function, where a parameter of the subscription operation includes the first identifier;
receive an event identifier of the subscription operation sent by the second network function;
associate the event identifier with the first identifier, or associate the event identifier with the one or more first communication devices associated with the first identifier; and
receive the event identifier sent by the second network function and the configuration parameter of the target service.

In some embodiments, the obtaining module 501 is configured to invoke a subscription operation from the second network function for the first communication device, where a parameter of the subscription operation includes the first identifier;
receive an event identifier of the subscription operation sent by the second network function;
associate the event identifier with the first communication device; and
receive the event identifier sent by the second network function and the configuration parameter of the target service.

In some embodiments, the obtaining module 501 is further configured to send a UE route selection policy URSP to the first communication device on the basis of the application data.

In some embodiments, the obtaining module 501 is further configured to send the network data, the session data or the service instance data to a third network function;
determine whether QoS requested by the first communication device is met or not on the basis of the allowed QoS information included in the network data, the session data or the service instance data; and
send IP address range information to the third network function on the basis of the default maximum quantity of connectable devices of the first communication device included in the network data, the session data or the service instance data.

In some embodiments, the obtaining module 501 is further configured to send the gateway information data to the third network function; and
send IP address range information to the third network function on the basis of the maximum quantity of connectable devices of the first communication device included in the gateway information data.

In some embodiments, the obtaining module 501 is further configured to receive a service parameter for the first identifier or the second identifier.

In some embodiments, the obtaining module 501 is further configured to send the service parameter to the second network function on the basis of the subscription data; and
send the service parameter to the second network function on the basis of the application data.

In some embodiments, the obtaining module 501 is further configured to determine to send the service parameter to the second network function on the basis of the subscription data; and
determine to send the service parameter to the second network function on the basis of the application data.

In some embodiments, in a case that the service parameter indicates creating the network, the session or the service instance of the target service, the obtaining module 501 is further configured to send the service parameter to the second network function on the basis of the quantity of networks, the quantity of sessions or the quantity of service instances of the target service included in the subscription data; and
send the service parameter to the second network function on the basis of the first indication information included in the subscription data.

In some embodiments, in a case that the service parameter indicates creating the network, the session or the service instance of the target service, the obtaining module 501 is configured to send the service parameter to the second network function on the basis of a quantity of records of the application data.

In some embodiments, the obtaining module 501 sends the PDU session information in the application data and the PDU session information in the network data, the session data or the service instance data to the second network function on the basis of the service parameter.

In some embodiments, the service parameter includes at least one of the following:
the network identifier, the session identifier or the service instance identifier of the target service;
the PDU session information;
service operation information, including any one of a create operation, an add operation, a release operation, a delete operation and an update operation;
the identifier of the first communication device;
the maximum quantity of connectable devices of the first communication device;
the QoS information of the first communication device, used for indicating the non-3GPP access QoS information of the first communication device; and
the identification information, used for identifying the control message of the target service sent to the first communication device or the control message of the target service sent by the first communication device.

In some embodiments, the PDU session information includes at least one of the following:
a data network name DNN;
single network slice selection assistance information S-NSSAI;
a PDU session identifier ID; and
an identifier of a user terminal to which the PDU session belongs.

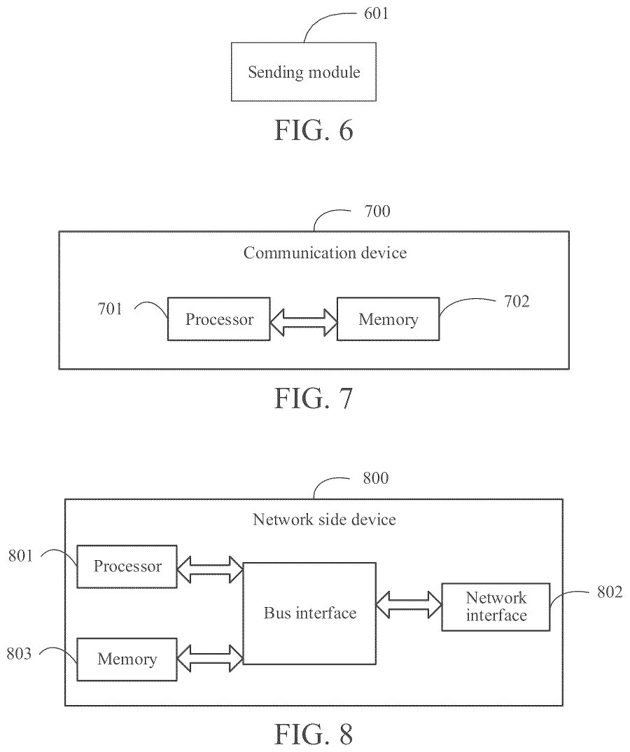

FIG. 6 is a schematic structural diagram II of the parameter obtaining apparatus provided by an embodiment of this application. As shown in FIG. 6, the parameter obtaining apparatus provided by this embodiment includes:
a sending module 601, configured to send a configuration parameter of a target service to a first network function on the basis of a first identifier or a second identifier, where the configuration parameter includes at least one of the following:
   subscription data of the target service;
   application data of the target service;
   network data, session data or service instance data of the target service; and
   gateway information data of the target service.

The first identifier is associated with the second identifier, and the first identifier or the second identifier is associated with one or more first communication devices.

In some embodiments, the subscription data includes at least one of the following:
the first identifier, used for associating the subscription data;
the second identifier associated with the first identifier, used for associating the subscription data;
protocol data unit PDU session information, used for indicating a PDU session, where the PDU session is used for transmission of a control message of the target service;
a quantity of networks, a quantity of sessions or a quantity of service instances of the target service, used for indicating the quantity of networks, sessions or service instances of the target service that are allowed to be created; and
first indication information, used for indicating a network function that allows requesting a target network to control the target service.

In some embodiments, the application data includes at least one of the following:
the first identifier, used for associating the application data or subscription data associated with the application data;
the second identifier associated with the first identifier, used for associating the application data or subscription data associated with the application data;
a network identifier, a session identifier or a service instance identifier of the target service;
PDU session information, used for indicating a PDU session, where the PDU session is used for carrying a network or a session or a service instance of the target service;
a quantity of networks, a quantity of sessions or a quantity of service instances of the target service, used for indicating the quantity of existing or created networks, sessions or service instances of the target service;
a subnet address, used for indicating subnet address information of the target service; and
a subnet mask, used for indicating subnet mask information of the target service.

In some embodiments, the network data, the session data or the service instance data includes at least one of the following:
the first identifier, used for associating the network data, the session data or the service instance data;
the second identifier associated with the first identifier, used for associating the network data, the session data or the service instance data;
a network identifier, a session identifier or a service instance identifier of the target service;
PDU session information, used for indicating a PDU session, where the PDU session is used for carrying a network or a session or a service instance of the target service;
allowed QoS information, used for indicating QoS information allowed and supported by a target network for data in the network or the session or the service instance;
second indication information, used for indicating at least one of the PDU session, the network, the session and the service instance, to transmit or not transmit a control message of the target service, or to transmit only or not only a data message of the target service; and
a default maximum quantity of connectable devices of the first communication device, used for determining an address range or an address range size sent to the first communication device.

In some embodiments, the gateway information data includes at least one of the following:
the first identifier, used for associating the gateway information data;
the second identifier associated with the first identifier, used for associating the gateway information data;
the identifier of the first communication device;
a maximum quantity of connectable devices of the first communication device, used for determining an address range or an address range size sent to the first communication device;
QoS information of the first communication device, used for indicating non-3GPP access QoS information of the first communication device; and
identification information, used for identifying a control message of the target service sent to the first communication device or a control message of the target service sent by the first communication device.

In some embodiments, the first identifier includes at least one of the following: a subscription permanent identifier SUPI; the PDU session information; the network identifier, the session identifier or the service instance identifier of the target service; and the identifier of the first communication device.

The second identifier includes at least one of the following: the identifier of the first communication device; and a generic public subscription identifier GPSI.

In some embodiments, the parameter obtaining apparatus further includes a receiving module, configured to receive invoking a subscription operation of the first network function, where a parameter of the subscription operation includes the first identifier;
send an event identifier of the subscription operation to the first network function; and
in a case that the configuration parameter of the target service changes, send the event identifier and the configuration parameter of the target service to the first network function.

In some embodiments, the receiving module is configured to receive a service parameter sent by the first network function.

In some embodiments, the receiving module is configured to receive the PDU session information in the application data and the PDU session information in the network data, the session data or the service instance data sent by the first network function.

In some embodiments, the service parameter includes at least one of the following:
the network identifier, the session identifier or the service instance identifier of the target service;
the PDU session information;
service operation information, including any one of a create operation, an add operation, a release operation, a delete operation and an update operation;
the identifier of the first communication device;
the maximum quantity of connectable devices of the first communication device;
the QoS information of the first communication device, used for indicating the non-3GPP access QoS information of the first communication device; and
the identification information, used for identifying the control message of the target service sent to the first communication device or the control message of the target service sent by the first communication device.

In some embodiments, the PDU session information includes at least one of the following:
a data network name DNN;
single network slice selection assistance information S-NSSAI;
a PDU session identifier ID; and
an identifier of a user terminal to which the PDU session belongs.

The parameter obtaining apparatus in this embodiment of this application may be an electronic device, for example, an electronic device with an operating system, or a component in an electronic device, for example, an integrated circuit or a chip. The electronic device may be a terminal or other devices other than the terminal. Exemplarily, the terminal may include, but not limited to, the types of the terminal 11 listed above, and the other devices may be servers, Network Attached Storages (NASs), etc., which is not specifically limited in this embodiment of this application.

The parameter obtaining apparatus provided by this embodiment of this application can implement processes implemented by the method embodiment of FIG. 2 to FIG. 4 and achieve the same technical effects. In order to avoid repetition, details will not be described here.

FIG. 7 is a schematic structural diagram of a communication device provided by an embodiment of this application. As shown in FIG. 7, the communication device 700 includes a processor 701 and a memory 702. The memory 702 stores a program or an instruction runnable on the processor 701. For example, when the communication device 700 is the first network function, the program or the instruction, when being executed by the processor 701, implements steps of the parameter obtaining method embodiment of the first network function and can achieve the same technical effects. When the communication device 700 is the second network function, the program or the instruction, when being executed by the processor 701, implements steps of the parameter obtaining method embodiment of the second network function and can achieve the same technical effects. In order to avoid repetition, details will not be described here.

An embodiment of this application further provides a first network function, including a processor and a communication interface. The processor is configured to learn a configuration parameter of a target service on the basis of a first identifier or a second identifier. The configuration parameter includes at least one of the following: subscription data of the target service; application data of the target service; network data, session data or service instance data of the target service; and gateway information data of the target service. The first identifier is associated with the second identifier, and the first identifier or the second identifier is associated with one or more first communication devices. The first network function embodiment corresponds to the above method embodiment of the first network function side, and all implementation processes and implementations of the above method embodiment are applicable to the first network function embodiment and can achieve the same technical effects.

An embodiment of this application further provides a second network function, including a processor and a communication interface. The communication interface is configured to send a configuration parameter of a target service to a first network function on the basis of a first identifier or a second identifier. The configuration parameter includes at least one of the following: subscription data of the target service; application data of the target service; network data, session data or service instance data of the target service; and gateway information data of the target service. The first identifier is associated with the second identifier, and the first identifier or the second identifier is associated with one or more first communication devices. The second network function embodiment corresponds to the above method embodiment of the second network function side, and all implementation processes and implementations of the above method embodiment are applicable to the second network function embodiment and can achieve the same technical effects.

FIG. 8 is a schematic structural diagram of a network side device provided by an embodiment of this application. As shown in FIG. 8, the network side device 800 includes: a processor 801, a network interface 802 and a memory 803. The network interface 802 is, for example, a Common Public Radio Interface (CPRI).

For example, the network side device 800 in this embodiment of this application further includes: an instruction or a program stored in the memory 803 and runnable in the processor 801. The processor 801 invokes the instruction or the program in the memory 803 to execute methods executed by various modules shown in FIG. 5 or FIG. 6 and achieves the same technical effects. In order to avoid repetition, details will not be repeated here.

An embodiment of this application further provides a parameter obtaining system, including: a first network function and a second network function. The first network function may be configured to execute steps of the parameter obtaining method of the first network function as described above. The second network function may be configured to execute steps of the parameter obtaining method of the second network function as described above.

An embodiment of this application further provides a readable storage medium. The readable storage medium may be non-transient or non-volatile. The readable storage medium stores a program or an instruction therein. The program or the instruction, when being executed by a processor, implements processes of the parameter obtaining method embodiment and can achieve the same technical effects. In order to avoid repetition, details will not be repeated here.

The processor is the processor in the terminal in the above embodiment. The readable storage medium includes a computer-readable storage medium. Examples of the computer-readable storage medium includes a non-transitory computer-readable storage medium, such as a computer read-only memory ROM, a random access memory RAM, a magnetic disk or an optical disk.

An embodiment of this application further provides a chip, including a processor and a communication interface. The communication interface is coupled to the processor. The processor is configured to run a program or an instruction to implement processes of the parameter obtaining method embodiment, and can achieve the same technical effects. In order to avoid repetition, details will not be described here.

It should be understood that the chip mentioned in this embodiment of this application may also be called a system on chip, a system chip, a chip system, a system on a chip or the like.

An embodiment of this application further provides a computer program/program product. The computer program/program product is stored in a storage medium. The computer program/program product is executed by at least one processor to implement processes of the parameter obtaining method embodiment, and can achieve the same technical effects. In order to avoid repetition, details will not be described here.

It should be noted that the term “include”, “comprise”, or any other variant thereof is intended to cover a non-exclusive inclusion, such that a process, method, article or apparatus that includes a series of elements includes not only those elements but also other elements not specifically listed, or elements that are inherent to the process, method, article or apparatus. In the absence of further limitation, an element defined by the phrase “including a . . . ” does not exclude the presence of the same element in the process, method, article or apparatus including the element. In addition, it should be noted that the scope of the method and apparatus in the implementations of this application is not limited to performing functions in the order shown or discussed, but also may include performing functions in a substantially simultaneous manner or in a reverse order according to the functions involved. For example, the described methods may be performed in a different order from that described, and various steps may also be added, omitted, or combined. In addition, features described with reference to some examples, embodiments and implementations may be combined in other examples.

Through the description of the above implementations, those skilled in the art can clearly understand that the methods according to the above embodiments can be implemented by means of software plus a necessary general hardware platform, and of course, they can also be implemented by hardware, but in many cases the former is a better implementation. Based on such an understanding, the technical solution of this application essentially or for the part that contributes to the related art can be embodied in the form of a software product, and the computer software product is stored in a storage medium (such as an ROM/RAM, a magnetic disk or an optical disk) and includes several instructions to enable a terminal facility (which may be a mobile phone, a computer, a server, an air conditioner, a network device or the like) to execute the method described in the embodiments of this application.

The embodiments of this application have been described above with reference to the accompanying drawings. However, this application is not limited to the implementations described above, and the implementations described above are merely exemplary and not limitative. Those of ordinary skill in the art may make various variations under the teaching of this application without departing from the spirit of this application and the protection scope of the claims, and such variations shall all fall within the protection scope of this application.

What is claimed is:

1. A parameter obtaining method, comprising:
learning, by a first network function, a configuration parameter of a target service on the basis of a first identifier or a second identifier, wherein the configuration parameter comprises application data of the target service,
wherein the first identifier is associated with the second identifier, and the first identifier or the second identifier is associated with one or more first communication devices.

2. The parameter obtaining method according to claim 1, wherein the application data comprises at least one of the following:
a network identifier of the target service; or
Protocol Data Unit (PDU) session information, used for indicating a PDU session, wherein the PDU session is used for a network or a session or a service instance of the target service.

3. The parameter obtaining method according to claim 1,
wherein:
the first identifier comprises at least one of the following: a Subscription Permanent Identifier (SUPI); PDU session information; a network identifier, a session identifier or a service instance identifier of the target service; or a identifier of the first communication device; and
the second identifier comprises at least one of the following: the identifier of the first communication device; or a Generic Public Subscription Identifier (GPSI).

4. The parameter obtaining method according to claim 1, wherein the learning, by a first network function, a configuration parameter of a target service on the basis of a first identifier comprises:
obtaining, by the first network function, the configuration parameter of the target service from a second network function on the basis of the first identifier.

5. The parameter obtaining method according to claim 4, wherein the obtaining, by the first network function, the configuration parameter of the target service from a second network function on the basis of the first identifier comprises:
invoking, by the first network function, a subscription operation from the second network function, wherein a parameter of the subscription operation comprises the first identifier;
receiving, by the first network function, an event identifier of the subscription operation sent by the second network function;
associating, by the first network function, the event identifier with the first identifier, or associating the event identifier with the one or more first communication devices associated with the first identifier; and
receiving, by the first network function, the event identifier sent by the second network function and the configuration parameter of the target service.

6. The parameter obtaining method according to claim 4, wherein the obtaining, by the first network function, the configuration parameter of the target service from a second network function on the basis of the first identifier comprises:
invoking, by the first network function, a subscription operation from the second network function for the first communication device, wherein a parameter of the subscription operation comprises the first identifier;
receiving, by the first network function, an event identifier of the subscription operation sent by the second network function;
associating, by the first network function, the event identifier with the first communication device; and
receiving, by the first network function, the event identifier sent by the second network function and the configuration parameter of the target service.

7. The parameter obtaining method according to 1, wherein when the configuration parameter comprises the application data, the method further comprises:
sending, by the first network function, a UE Route Selection Policy (URSP) to the first communication device on the basis of the application data.

8. The parameter obtaining method according to claim 1, wherein the configuration parameter further comprises: subscription data of the target service; network data, session data or service instance data of the target service; or gateway information data of the target service,
wherein the subscription data comprises at least one of the following:
the first identifier, used for associating the subscription data;
the second identifier associated with the first identifier, used for associating the subscription data;
Protocol Data Unit (PDU) session information, used for indicating a PDU session, wherein the PDU session is used for transmission of a control message of the target service;
a quantity of networks, a quantity of sessions or a quantity of service instances of the target service, used for indicating the quantity of allowed networks, sessions or service instances of the target service; or
first indication information, used for indicating a network function that allows requesting a target network to control the target service,
wherein the network data, the session data or the service instance data comprises at least one of the following:
the first identifier, used for associating the network data, the session data or the service instance data;
the second identifier associated with the first identifier, used for associating the network data, the session data or the service instance data;
a network identifier, a session identifier or a service instance identifier of the target service;
PDU session information, used for indicating a PDU session, wherein the PDU session is used for a network or a session or a service instance of the target service;
allowed Quality of Service (QoS) information, used for indicating QoS information
allowed by a target network for data in the network or the session or the service instance;
second indication information, used for indicating at least one of the PDU session, the network, the session and the service instance, to transmit or not transmit a control message of the target service, or to transmit only or not only a data message of the target service; or
a default maximum quantity of connectable devices of the first communication device, used for determining an address range or an address range size sent to the first communication device,
wherein the gateway information data comprises at least one of the following:
the first identifier, used for associating the gateway information data;
the second identifier associated with the first identifier, used for associating the gateway information data;
an identifier of the first communication device;
a maximum quantity of connectable devices of the first communication device, used for determining an address range or an address range size sent to the first communication device;
QoS information of the first communication device, used for indicating non-3GPP access QoS information of the first communication device; or
identification information, used for identifying a control message of the target service sent to the first communication device or a control message of the target service sent by the first communication device.

9. The parameter obtaining method according to claim 2, wherein the application data further comprises at least one of the following:
the first identifier, used for associating the application data or subscription data associated with the application data;
the second identifier associated with the first identifier, used for associating the application data or subscription data associated with the application data;
a session identifier or a service instance identifier of the target service;
a quantity of networks, a quantity of sessions or a quantity of service instances of the target service, used for indicating the quantity of existing or created networks, sessions or service instances of the target service;
a subnet address, used for indicating subnet address information of the target service; or
a subnet mask, used for indicating subnet mask information of the target service.

10. The parameter obtaining method according to claim 8, wherein the method further comprises at least one of the following:
sending, by the first network function, the network data, the session data or the service instance data to a third network function;
determining, by the first network function, whether QoS requested by the first communication device is met or not on the basis of the allowed QoS information comprised in the network data, the session data or the service instance data;
sending, by the first network function, IP address range information to the third network function on the basis of the default maximum quantity of connectable devices of the first communication device comprised in the network data, the session data or the service instance data;
sending, by the first network function, the gateway information data to a third network function; or
sending, by the first network function, IP address range information to the third network function on the basis of the maximum quantity of connectable devices of the first communication device comprised in the gateway information data.

11. The parameter obtaining method according to claim 1, wherein before the learning, by a first network function, a configuration parameter of a target service on the basis of a first identifier or a second identifier, the method further comprises:
receiving, by the first network function, a service parameter for the first identifier or the second identifier.

12. The parameter obtaining method according to claim 11, wherein the service parameter comprises at least one of the following:
the network identifier, the session identifier or the service instance identifier of the target service;
Protocol Data Unit (PDU) session information;
service operation information, comprising any one of a create operation, an add operation, a release operation, a delete operation and an update operation;
the identifier of the first communication device;
the maximum quantity of connectable devices of the first communication device;
Quality Of Service (QoS) information of the first communication device, used for indicating the non-3GPP access QoS information of the first communication device; or
the identification information, used for identifying the control message of the target service sent to the first communication device or the control message of the target service sent by the first communication device.

13. The parameter obtaining method according to claim 2, wherein the PDU session information comprises at least one of the following:
a Data Network Name (DNN);
Single Network Slice Selection Assistance Information (S-NSSAI);
a PDU session Identifier (ID); or
an identifier of a user terminal to which the PDU session belongs.

14. A parameter obtaining method, comprising:
sending, by a second network function, a configuration parameter of a target service to a first network function on the basis of a first identifier or a second identifier, wherein the configuration parameter comprises application data of the target service,
wherein the first identifier is associated with the second identifier, and the first identifier or the second identifier is associated with one or more first communication devices.

15. The parameter obtaining method according to claim 14, wherein the application data comprises at least one of the following:
a network identifier of the target service; or
Protocol Data Unit (PDU) session information, used for indicating a PDU session, wherein the PDU session is used for carrying a network or a session or a service instance of the target service.

16. The parameter obtaining method according to claim 14,
wherein:
the first identifier comprises at least one of the following: a Subscription Permanent Identifier (SUPI); the PDU session information; a network identifier, a session identifier or a service instance identifier of the target service; or the identifier of the first communication device; and
the second identifier comprises at least one of the following: the identifier of the first communication device; or a Generic Public Subscription Identifier (GPSI).

17. The parameter obtaining method according to claim 14, wherein the configuration parameter further comprises: subscription data of the target service; network data, session data or service instance data of the target service; or gateway information data of the target service,
wherein the subscription data comprises at least one of the following:
the first identifier, used for associating the subscription data;
the second identifier associated with the first identifier, used for associating the subscription data;
Protocol Data Unit (PDU) session information, used for indicating a PDU session, wherein the PDU session is used for transmission of a control message of the target service;
a quantity of networks, a quantity of sessions or a quantity of service instances of the target service, used for indicating the quantity of allowed networks, sessions or service instances of the target service; or
first indication information, used for indicating a network function that allows requesting a target network to control the target service,
wherein the network data, the session data or the service instance data comprises at least one of the following:
the first identifier, used for associating the network data, the session data or the service instance data;
the second identifier associated with the first identifier, used for associating the network data, the session data or the service instance data;
a network identifier, a session identifier or a service instance identifier of the target service;
PDU session information, used for indicating a PDU session, wherein the PDU session is used for a network or a session or a service instance of the target service;
allowed Quality of Service (QoS) information, used for indicating QoS information allowed by a target network for data in the network or the session or the service instance;
second indication information, used for indicating at least one of the PDU session, the network, the session and the service instance, to transmit or not transmit a control message of the target service, or to transmit only or not only a data message of the target service; or
a default maximum quantity of connectable devices of the first communication device, used for determining an address range or an address range size sent to the first communication device,
wherein the gateway information data comprises at least one of the following:
the first identifier, used for associating the gateway information data;
the second identifier associated with the first identifier, used for associating the gateway information data;
an identifier of the first communication device;
a maximum quantity of connectable devices of the first communication device, used for determining an address range or an address range size sent to the first communication device;
QoS information of the first communication device, used for indicating non-3GPP access QoS information of the first communication device; or
identification information, used for identifying a control message of the target service sent to the first communication device or a control message of the target service sent by the first communication device.

18. The parameter obtaining method according to claim 15, wherein the PDU session information comprises at least one of the following:
a Data Network Name (DNN);
Single Network Slice Selection Assistance Information (S-NSSAI);
a PDU session Identifier (ID); or
an identifier of a user terminal to which the PDU session belongs.

19. A parameter obtaining apparatus, comprising: a processor; and a memory having a computer program stored thereon, wherein the computer program, when executed by the processor, causes the processor to perform operations comprising:
learning a configuration parameter of a target service on the basis of a first identifier or a second identifier, wherein the configuration parameter comprises application data of the target service,
wherein the first identifier is associated with the second identifier, and the first identifier or the second identifier is associated with one or more first communication devices.

20. A parameter obtaining apparatus, comprising: a processor; and a memory having a computer program stored thereon, wherein the computer program, when executed by the processor, causes the processor to perform the parameter obtaining method according to claim 14.
